(19) United States
(12) Patent Application Publication
(10) Pub. No.: US 2025/0342302 A1
(43) Pub. Date: Nov. 6, 2025

(54) SYSTEM AND METHOD FOR MINIMIZING INSERTION LOSSES AND LOOP INDUCTANCE IN A PCB LAYOUT

(71) Applicant: Western Digital Technologies, Inc., San Jose, CA (US)

(72) Inventor: Vishwajith Poojari, Bengaluru (IN)

(73) Assignee: Western Digital Technologies, Inc., San Jose, CA (US)

(21) Appl. No.: 18/651,922

(22) Filed: May 1, 2024

(51) Int. Cl. G06F 30/398; H05K 3/00

(52) U.S. Cl. CPC G06F 30/398; H05K 3/0005

(57) ABSTRACT

Systems and methods relate to accounting for insertion losses and/or loop inductance during the design and layout phase of a PCB. Insertion losses are measured along signal paths, and/or loop inductance is measured along current loops, and if measured values are above predefined maximums, a PCB designer is prompted to redesign the PCB layout.

### BACKGROUND

The strong growth in demand for portable consumer electronics is driving the need for high-capacity storage devices. Non-volatile semiconductor memory devices, such as flash memory storage cards, are widely used to meet the ever-growing demands on digital information storage and exchange. Their portability, versatility and rugged design, along with their high reliability and large capacity, have made such memory devices ideal for use in a wide variety of electronic devices, including for example digital cameras, digital music players, video game consoles, PDAs, cellular telephones and solid state drives.

Semiconductor packages are typically mounted on a printed circuit board (PCB) along with a controller, capacitors and other electronic components. The packages, controller and/or other components may be electrically connected to solder balls on a bottom surface of the PCB, or to gold plated fingers along an edge of the PCB. The PCB may have multiple conductive layers each having a pattern of conductive traces, with each such layer separated by an electrically insulating dielectric layer. The different conductive layers may be electrically coupled to each other by conductive vias formed through the PCB.

Current high-speed memory devices use PCIe (Peripheral Component Interconnect Express) or other high-speed serial interface standard for communicating signals. These serial interfaces may be implemented using a SERDES (Serializer/Deserializer) technology as the physical layer to serialize data on the transmitting end and deserialize it on the receiving end. It is important in high-speed signal communications through a PCB to minimize noise and insertion losses as electrical signals travel through a signal pathway of traces and vias on the PCB. Insertion loss refers to the reduction in signal amplitude or power as a signal travels along a signal pathway of traces and vias on a PCB. In general, insertion loss increases with the length of the signal pathway through the traces and vias of a PCB.

As mentioned, a PCB may include capacitors, which may take the form of decoupling capacitors. Decoupling capacitors are used to stabilize the power supply to memory devices on the PCB by filtering out noise, minimizing voltage fluctuations, and ensuring near-instantaneous delivery of power during transient load conditions on the memory devices. Ideally, decoupling capacitors are placed physically near to an associated memory device on the PCB.

However, physical proximity does not guarantee electrical proximity. It may happen that a decoupling capacitor is near to an associated memory device, but the electrical current pathway may involve a long distance through various traces and/or vias. Long current pathways between a decoupling capacitor and its associated memory device may result in high loop inductance, especially in high-speed interfaces. Loop inductance refers to the inductance created by the current pathway between a decoupling capacitor and its associated memory device in a PCB. It is desirable to minimize loop inductance as it can cause noise and interference, voltage droops and spikes from the decoupling capacitor, and can degrade signal integrity.

The design and layout of PCBs involves a number of steps, including for example the high-level schematic design phase, component selection and placement, and electrical routing where the electrical connections of traces and vias are defined. These phases are performed by a PCB designer using CAD or other electronic design automation software platform. While signal loss and loop inductance are known parameters degrading the operation of high-speed PCB memory devices, at present, there is no automated system or method for measuring or otherwise accounting for these parameters during the PCB design and layout phase.

### DESCRIPTION OF THE DRAWINGS

FIG. 1 is a schematic block diagram of a computing system for implementing embodiments of the present technology.

FIG. 2 is a top view of a graphical user interface displaying a PCB under design according to embodiments of the present technology.

FIG. 3 is a cross-sectional edge view of a graphical user interface displaying a PCB under design according to embodiments of the present technology.

FIG. 4 is a flowchart of the operation of the insertion loss tool according to embodiments of the present technology.

FIG. 5 is a top view of a graphical user interface displaying a PCB under design according to embodiments of the present technology.

FIG. 6 is a cross-sectional edge view of a graphical user interface displaying a PCB under design according to embodiments of the present technology.

FIG. 7 is a further cross-sectional edge view of a graphical user interface displaying a PCB under design according to embodiments of the present technology.

FIG. 8 is a flowchart of the operation of the loop inductance tool according to embodiments of the present technology.

FIG. 9 is a graph showing inductance loss versus frequency for two different decoupling capacitor PCB designs according to embodiments of the present technology.

FIG. 10 is a schematic block diagram of a computing environment according to embodiments of the present technology.

### DETAILED DESCRIPTION

The present technology will now be described with reference to the figures, which in embodiments, relate to systems and methods for accounting for insertion losses and/or loop inductance during the design and layout phase of a PCB. In one example, an insertion loss software tool may be integrated into an electronic design automation software platform. The insertion loss software tool analyzes the signal pathways of traces and vias proposed by the PCB designer and determines whether the signal pathways are likely to result in insertion losses above some predefined threshold. If so, the PCB designer is alerted so that the designer can redesign the electrical signal routings within the PCB to reduce insertion losses.

In another example, a loop inductance software tool may be integrated into an electronic design automation software platform. The loop inductance software tool analyzes the current pathways of traces and vias proposed by the PCB designer and determines whether the current pathways are likely to result in loop capacitance above some predefined threshold. If so, the PCB designer is alerted so that the designer can move or remove a decoupling capacitor or otherwise redesign the power and/or ground pathways within the PCB to reduce loop capacitance.

As used herein, “PCB designer” refers to any of a wide variety of technicians associated with the design and/or verification of a PCB to be used to electrically interconnect various semiconductor dies and other components. In addition to those traditionally termed PCB designers, the term as used herein may also or alternatively refer to other technicians associated with PCB design, layout or test, including for example hardware engineers, electrical engineers, embedded system engineers, manufacturing engineers, quality assurance/test engineers and firmware engineers.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

The terms “top” and “bottom,” “upper” and “lower” and “vertical” and “horizontal,” and forms thereof, as may be used herein are by way of example and illustrative purposes only, and are not meant to limit the description of the technology inasmuch as the referenced item can be exchanged in position and orientation. Also, as used herein, the terms “substantially” and/or “about” mean that the specified dimension or parameter may be varied within an acceptable manufacturing tolerance for a given application. In one embodiment, the acceptable manufacturing tolerance is ±0.15 mm, or alternatively, ±2.5% of a given dimension.

For purposes of this disclosure, a physical or electrical connection may be a direct connection or an indirect connection (e.g., via one or more other parts). In some cases, when a first element is referred to as being connected, affixed, mounted or coupled to a second element (either physically or electrically), the first and second elements may be directly connected, affixed, mounted or coupled to each other or indirectly connected, affixed, mounted or coupled to each other (either physically or electrically). When a first element is referred to as being directly connected, affixed, mounted or coupled to a second element, then there are no intervening elements between the first and second elements (other than possibly an adhesive or melted metal used to connect, affix, mount or couple the first and second elements).

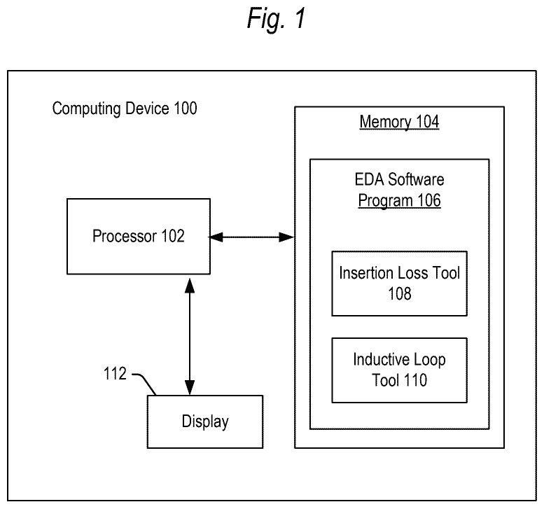

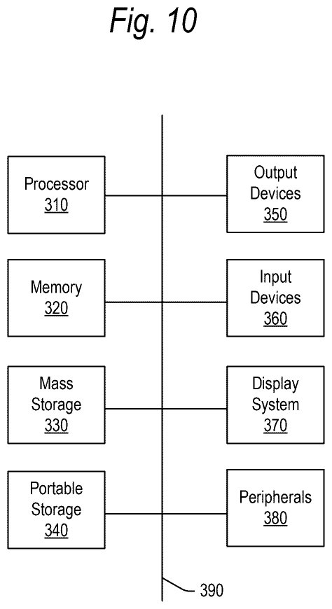

FIG. 1 is a schematic block diagram of a sample computing device 100 for implementing embodiments of the present technology. A more detailed explanation of a sample computing device 100 is provided below with reference to FIG. 10, but in general, the computing device 100 may be a desktop, laptop, mobile hand-held computing device or other processing devices. The computing device 100 may include a processor 102 configured to control the operations of device 100, as well as facilitate communications between various components within device 100. The processor 102 may include a standardized processor, a specialized processor, a microprocessor, or the like that may execute instructions for controlling computing device 100.

The computing device 100 may further include a memory 104 that may store algorithms that may be executed by the processor 102. According to an example embodiment, the memory 104 may include RAM, ROM, cache, flash memory, a hard disk, and/or any other suitable storage component. As shown in FIG. 1, in one embodiment, the memory 104 may be a separate component in communication with the processor 102, but the memory 104 may be integrated into the processor 102 in further embodiments.

Memory 104 may store various data stores and/or software application programs executed by the processor 102 for controlling the operation of the computing device 100. For example, the memory 104 may store an electronic design automation (EDA) software program 106 which, when executed by processor 102, allows a PCB designer to design and layout all aspects of a PCB for use as a memory device. In accordance with aspects of the present technology, the EDA software program 106 may include an insertion loss software tool 108 and an inductive loop software tool 110, each of which is explained in greater detail below. In addition to the tools 108 and 110 of the present technology, the EDA software program 106 may implement a wide variety of other functionalities associated with the design and layout of a PCB, which functionalities are beyond the scope of the present technology but are known in the art. While the insertion loss software tool 108 and the inductive loop software tool 110 may be integrated into the EDA software program 106, in further embodiments, the insertion loss software tool 108 and/or the inductive loop software tool 110 may run independently of the EDA software program 106. The computing device 100 may further include a display 112 for displaying a graphical user interface as explained below.

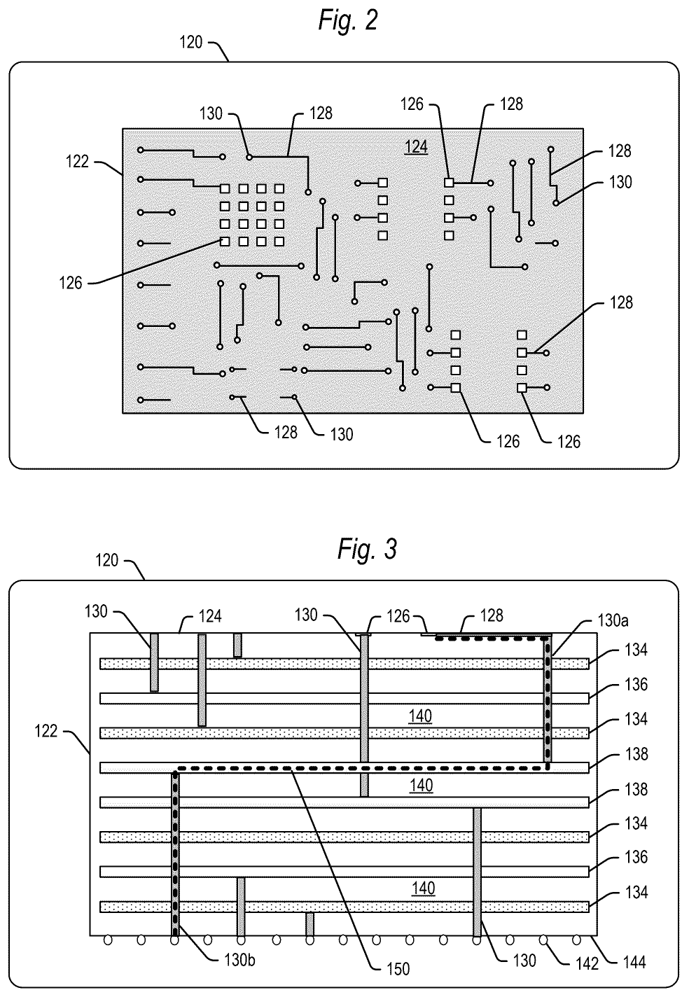

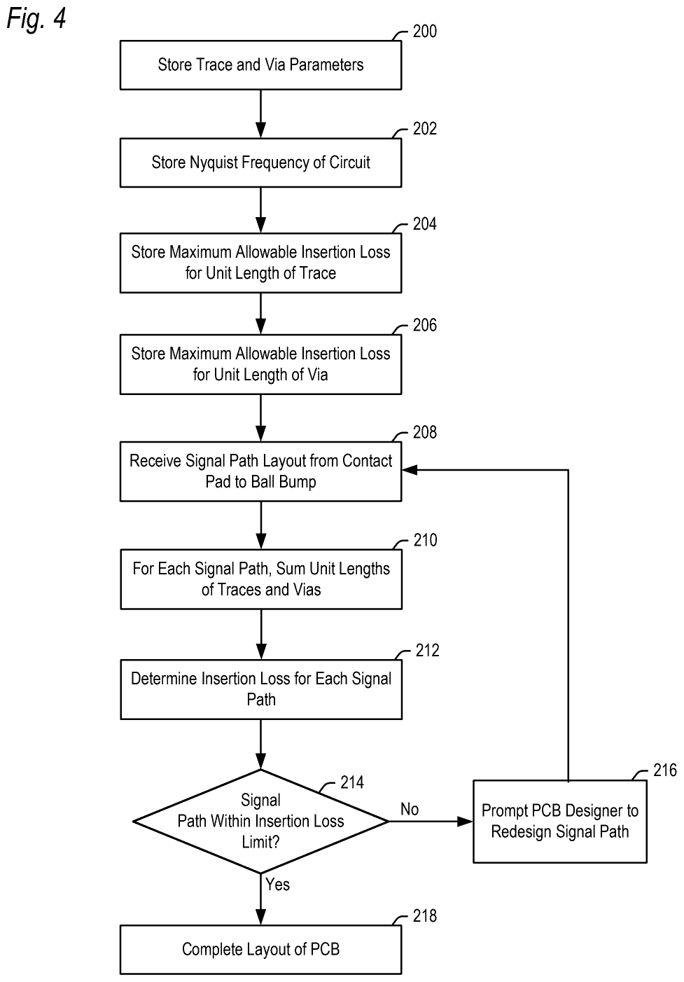

Operation of the insertion loss software tool 108 will now be explained with reference to FIGS. 2-4. The insertion loss software tool 108 is an algorithm capable of accounting for insertion losses during the design and layout of a PCB. The PCB may for example be used to implement memory storage and, when completed, may have mounted thereon any of a variety of electronic components including for example a processor, a non-volatile memory, volatile memory and passive components including resistors, capacitor and/or inductors. The PCB may further include a network of electrical traces and vias to carry signals between the electronic components, and to carry signals between the electronic component and a host device. The insertion loss software tool 108 of this embodiment is specifically related to ensuring that the insertion losses in a PCB due to lengths of the traces and/or vias is maintained below some predefined maximum in the finished PCB.

FIGS. 2 and 3 illustrate a graphical user interface (GUI) 120 displayed on the display 112 of the computing device 100 while running the EDA software program 106. The GUI display 120 of FIG. 2 illustrates a top view of a PCB 122, and the GUI display 120 of FIG. 3 illustrates a cross-sectional edge view of the PCB 122. The graphical illustration of a PCB 122 in FIG. 2 shows a top surface 124 of the PCB 122 including a layout of contact pads 126, electrical traces 128 and vias 130 (some of which are numbered in FIG. 2). The contact pads 126 are provided to receive electronic components such as control and/or memory dies, or passive components such as capacitors, resistors and/or inductors. The electrical traces 128 are provided to carry signals to and from the contact pads 126 in the top surface 124 of PCB 122. The vias 130 are provided to carry signals to and from the contact pads 126 and the traces 128 through a thickness of the PCB 122 as explained below with respect to FIG. 3. The pattern of pads 126, traces 128 and vias 130 is created by the PCB designer using the EDA software program 106. The GUI display 102 shown in FIG. 2 is by way of example only. Using the EDA software program, the PCB designer may provide GUI display 102 with any of a wide variety of other layouts for contact pads 126, traces 128 and/or vias 130 on the top surface 124 of PCB 122 in further embodiments.

The GUI display 120 of FIG. 3 illustrates a cross-sectional edge view of the PCB 122. The display 120 of FIG. 3 shows top surface 124 including contact pads 126, a trace 128 and vias 130 visible at the selected cross-section. The GUI display 120 of FIG. 3 further shows a number of interior layers of the PCB 122 including ground planes 134 (shown in with stippling), power planes 136 (shown with no shading) and signal planes 138 (shown with slight shading). Each of the ground, power and signal planes 134, 136, 138 are separated by an electrically insulating dielectric layer 140 (some of which layers are numbered). The GUI display 120 of FIG. 3 further illustrates a number of solder balls 142 to be mounted on a bottom surface 144 of the PCB 122. The GUI display 120 shown in FIG. 3 is by way of example only. The pattern of pads 126, traces 128, vias 130, ground planes 134, power planes 136, signal planes 138 and solder balls 142 is created by the PCB designer using the EDA software program 106. Using the EDA software program, the PCB designer may provide GUI display 120 with any of a wide variety of other layouts for the contact pads 126, traces 128, vias 130, ground planes 114, power planes 116, signal planes 118 and solder balls 142 in the cross-sectional edge view of PCB 122 in further embodiments.

While FIGS. 2 and 3 show a large number of traces 128 and vias 130, a relatively small number of these are used to carry data signals between the contact pads 126 on the top surface 124 and the solder balls 142 on the bottom surface 144 of PCB 122. FIG. 3 shows a dotted line highlighting one such signal path 150 between a contact pad 126 on surface 124 and solder ball 142 on surface 144. The signal path 150 shown in FIG. 3 includes a trace 128 on the top surface 144, a via 130a extending between the top surface 144 and a signal plane 138, electrical traces 128 (not shown) in signal plane 138, and via 130b extending from the signal plane 138 to the solder ball 142. It is understood that the PCB designer may provide signal path 150 with a wide variety of other traces 128, vias 130, signal planes 138 and routes through the PCB 122 in further examples. In general, a signal path may have a starting point at one of the first and second surfaces 124, 144 of the PCB 122, and an end point at one of the first and second surfaces 124, 144 of the PCB. Moreover, it is understood that the PCB designer may include 2, 3, 4, 5, 6, 7, 8 or more such signal paths between a contact pad 126 on surface 144 and solder ball 142 on surface 144.

In accordance with aspects of the present technology, as (or after) a PCB designer provides a layout of the one or more signal paths 150, the insertion loss software tool 108 analyzes the layout, and provides a warning when the one or more signal paths 150 are likely to result in insertion losses above some predefined maximum. Insertion loss can be calculated by the tool 108 using the below formula, Nyquist frequency and a predefined maximum allowable insertion loss limit, which can be fed into the tool by the PCB designer as constraint input. The signal attenuation factor of a signal path 150 of length l is:

$$AF ( l ) = {e}^{- \frac{1}{2} ( \frac{R}{{Z}_{0}} + {GZ}_{0} ) l} \qquad ( 1 )$$

The attenuation or signal loss factor may be expressed in dB:

$$dB loss = 20 {log}_{10} ( attenuation factor ) \qquad ( 2 )$$

### Thus:

$$Loss dB = - 10 {log}_{10} e [ \frac{R}{{Z}_{0}} + {GZ}_{0} ] l \qquad ( 3 )$$

The dB loss is directly proportional to the signal path line length. Thus, the above can be expressed as dB loss per unit length:

$$Loss dB ( pul ) = - 4.34 [ \frac{R}{{Z}_{0}} + {GZ}_{0} ] \qquad ( 4 )$$

The minus sign may be omitted (it is a dB loss, always to be subtracted from signal strength in dB. Thus, the total insertion loss per unit length of signal path transmission line may be given as:

$${α}_{t} = 4.34 [ \frac{R}{{Z}_{0}} + {GZ}_{0} ] dB \text{/length} \qquad ( 5 )$$

The R/z₀ component of the loss is proportional to the resistance, R, of the length per unit length, and is called the conductor loss and I due to the resistance of the conductors forming the transmission line. It is represented by α_{c}. The GZ₀ component of the loss is proportional to G, the conductance of the dielectric material and is called the dielectric loss. It is denoted by α_{d}. Thus:

$${α}_{t} = {α}_{C} + {α}_{d} ; {α}_{C} = \frac{4.34 R}{{Z}_{0}} ; {α}_{d} = 4.34 {GZ}_{0} . \qquad ( 6 )$$

All the required data for the above is known and can be input to the EDA software program 106. Trace width and spacing between the P and N signal are also known and can be input to the EDA software program 106. The maximum allowable insertion loss data may also be predefined and input into the EDA software program 106.

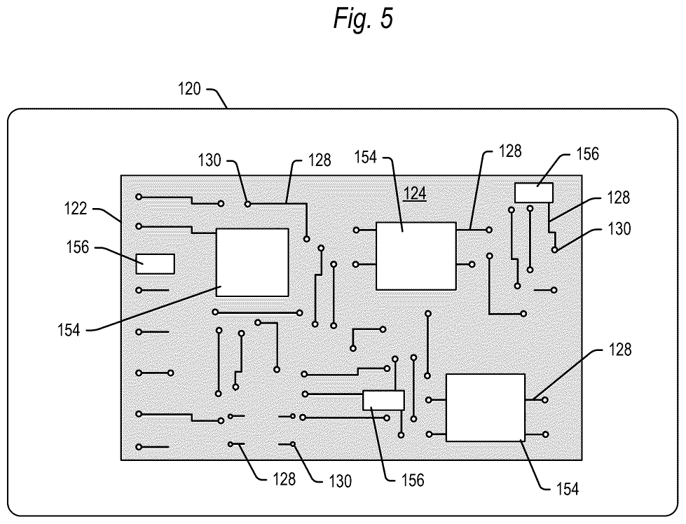

FIG. 5 is a flowchart showing the operation of the insertion loss tool 108. In step 200, the tool receives all trace and via parameters, possibly from the PCB designer, based on the PCB fabrication house specifications. These include the cross-sectional dimensions of traces 128 and vias 130, properties of the traces 128 and vias 130, such as dielectric constant (Dk) and lost tangent (Df), indicating losses per unit length, trace spacing for controlled impedance, add thickness of the layers of the PCB 122.

In step 202, the tool may also receive the Nyquist frequency of the signal paths. The Nyquist frequency is defined as half of the sampling rate of the signals through the traces 128 and vias 130. The Nyquist frequency is the highest frequency that the PCB 122 can reliably measure at a given sample rate, or one-half the given sample rate. In step 204, the tool may also receive the maximum allowable insertion loss of the signal paths. The maximum allowable insertion loss may be predefined based on fabrication house or standards specifications and may for example be 36 dB. This is the total summed across all signal paths 150. Other maximum allowable insertions loss values are possible. As an alternative, each individual signal path may have a predefined maximum allowable insertion loss. For example, if there are four signal paths 150 for transmitting signals, the total insertion loss for each signal path 150 may be the total signal loss across all signal paths divided by 4. Other properties of the PCB may be stored in step 200.

In step 208, the tool 108 receives from the PCB designer the layout of the PCB, including all defined signal paths 150, as shown for example in the GUI displays of FIGS. 2 and 3. In step 210, the tool sums the lengths of all signal paths, including for example signal path 150 in FIG. 3.

In step 214, the tool 108 calculates insertion losses for each signal path, using the determined signal path length(s) and the formulas (1)-(6) above. In embodiments, the traces 128 and vias 130 may be treated the same for purposes of calculating insertion losses for a given signal path. However, the traces 128 and vias 130 may have different electrical properties, and thus different insertion losses, per unit length. Thus, in further embodiments, the length of the trace(s) in a given signal path may be summed, and the insertion losses for the traces may be calculated using values unique to the traces, and the length of the via(s) in the given signal path may be summed, and the insertion losses for the vias may be calculated using values unique to the vias. Thereafter, the determined trace insertion loss and the determined via insertion loss for the signal path may be added together to give the total insertion loss of the signal path as a whole.

In step 214, the tool 108 determines whether the insertion losses exceed the predetermined maximum. Again, this may be calculated on each signal path 150, or on all signal paths 150 together. If it is determined in step 214 that the insertion loss for an individual signal path, or the signal paths as a whole, exceed the predetermined maximums, then the PCB designer is informed of this in step 216, and is prompted to redesign the signal paths in a way that will reduce the signal path lengths and insertion losses. In embodiments, the insertion loss tool 108 may make recommendations on how to reduce the one or more signal paths that exceed the predetermined maximum, for example by analyzing the proposed signal path and recognizing a path having shorter trace lengths and/or via lengths. The flow then returns to step 208 where the PCB designer can make changes to one or more of the signal paths 150. On the other hand, if it is determined in step 214 that the insertion loss for an individual signal path, or the signal paths as a whole, are within the predetermined maximums, then the flow continues to step 218 for the signal designer to complete the layout of the PCB 122.

As noted above, in addition to or instead of the insertion loss tool 108, the present technology may implement an loop inductance tool 110 in the layout of a PCB 120\2. Embodiments of the loop inductance tool 110 will now be described with reference to FIGS. 5-8. As shown in the top view of FIG. 5, the PCB designer may include a number of semiconductor dies 154 on PCB 122, for example on surface 124 of PCB 122. These semiconductor dies 154 may include for example memory dies such as non-volatile and volatile memory dies. The non-volatile memory dies may for example be NAND memory dies or so-called bit cost scaling, or BiCS, memory dies. Other types of non-volatile memory dies are possible. The volatile memory dies may for example be a random access memory such as DRAM or SRAM. Other types of volatile memory are possible.

High frequency PCBs such as those contemplated by the present technology typically use capacitors as a source of stable and near instantaneous current for semiconductor dies 154. Optimally, these capacitors, referred to as decoupling capacitors 156, should be placed close to the semiconductor dies 154 that they service. The top view of FIG. 5 shows a few sample decoupling capacitors 156, but there may be many more to service each semiconductor die 154.

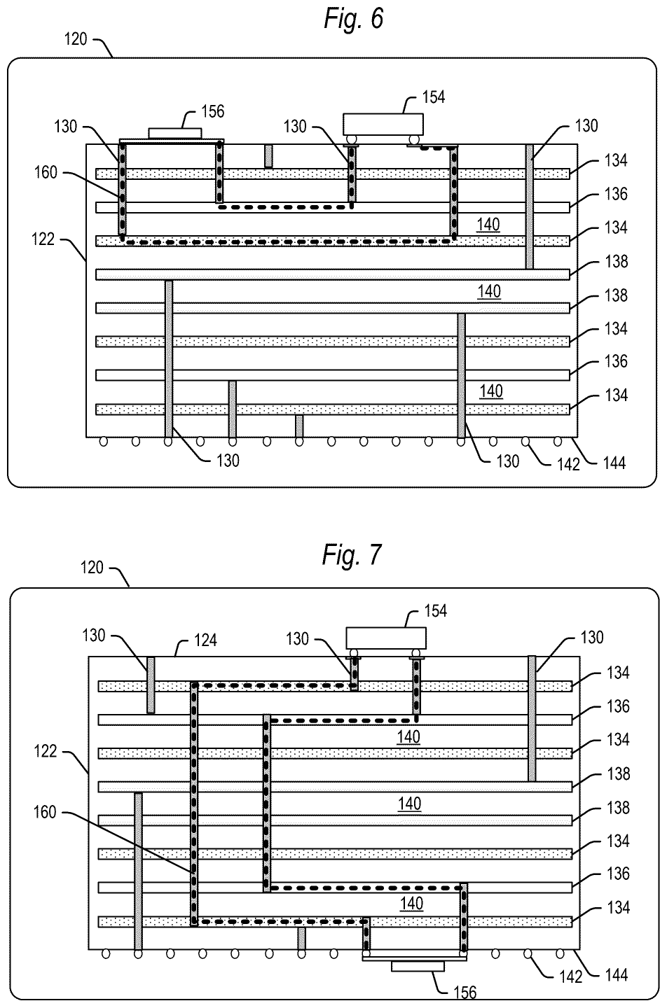

The proximity of a decoupling capacitor 156 to a current sink (such a semiconductor die 154) can affect the impedance of the power distribution network (PDN) of PCB 122. The impedance of the PDN determines how effectively it can supply stable and low-noise power to the semiconductor dies 154 and other electronic components on PCB 122. By placing the decoupling capacitors 156 close to their associated semiconductor dies 155, they are able to provide a low impedance path for high-frequency current loops. High-frequency currents, generated by the switching activities of the semiconductor dies 154, may flow in loops between the power supply and ground pins of the semiconductor dies 154. The cross-sectional edge view of FIG. 6 shows one such loop 160. The decoupling capacitor 156 placed near the semiconductor die 154 serves as a local reservoir of charge, supplying the high-frequency current demands with minimal impedance. This reduces the voltage droop and noise on the power supply lines, ensuring quick and stable power delivery to the semiconductor die 154.

A close proximity of the decoupling capacitor 156 to its associated current sink may also reduce the loop inductance of the high-frequency current path. Inductance in the power distribution network can lead to voltage spikes and ringing, degrading the performance of semiconductor dies 154 and causing electromagnetic interference (EMI). By minimizing loop inductance, the decoupling capacitors 156 help to maintain a lower impedance path for high-frequency currents, improving the overall integrity of the power distribution system.

Thus, PCB designers will generally place decoupling capacitors 156 close to their associated semiconductor die 154. However, a problem often overlooked by PCB designers is that physical proximity does not necessarily equate to electrical proximity. FIG. 5 shows the decoupling capacitor 156 physically close to its associated semiconductor die 154. FIG. 6 is a cross-sectional edge view of a decoupling capacitor 156 and its associated semiconductor die 154. As seen, while being physically close to each other, physical proximity does not necessarily equate to a short path travelled by the current, referred to herein as current loop 160. FIG. 7 is a further cross-sectional edge view where the decoupling capacitor 156 and its associated semiconductor die 154 are close to each other, aligned with each other on opposed surfaces of the PCB 122. However, again, physical proximity does not mean that the current loop 160 between decoupling capacitor 156 and semiconductor 154 is optimized.

In accordance with aspects of the present technology, the loop inductance tool 110 measures the loop inductance of each current loop between a decoupling capacitor 156 and its associated semiconductor die 154 to determine whether the loop inductance is above some predefined threshold. If so, the PCB designer is notified so that he or she can redesign the PCB layout to reduce the length of the current loop between a given decoupling capacitor 156 and its associated semiconductor die 154.

Loop inductance for a decoupling capacitor 156 is calculated by using the below formula:

$${L}_{eff} = \frac{Imaginary ( Z ( Power , GND pads of decap ) )}{2 \times π \times Frequency} \qquad ( 7 )$$

where L_{eff} is the effective loop inductance, Z (power, GND pads of decap) represents the Z-parameters of the port defined across the power and ground pads of the corresponding decoupling capacitor 156. 1 MHz frequency may be used in loop inductance extraction, though other frequencies are possible.

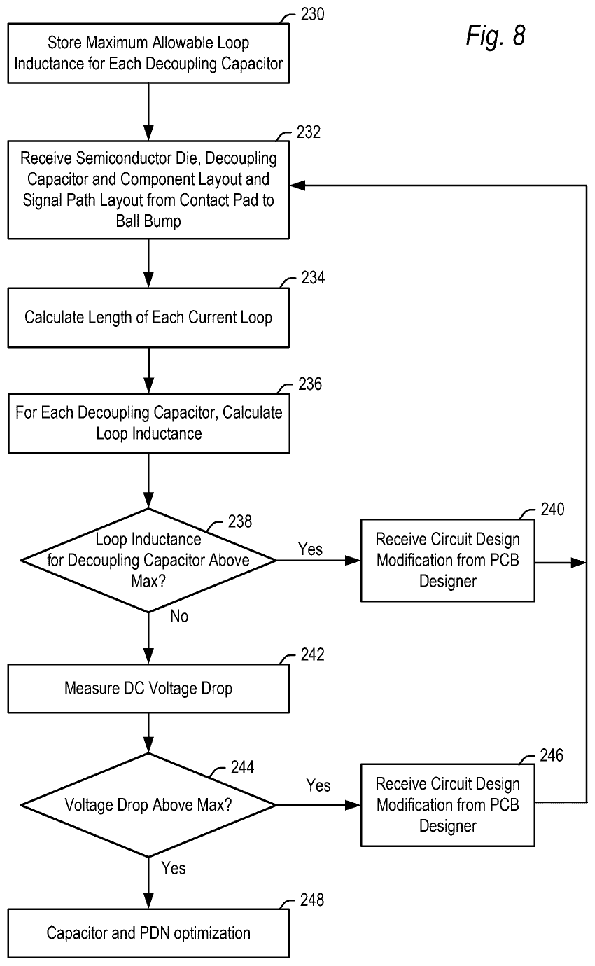

Operation of the loop inductance tool 110 will now be explained with reference to the flowchart of FIG. 8. The PCB designer inputs a value for the maximum allowable loop inductance for each decoupling capacitor inductance loop 160, which value is stored in step 230. The maximum allowable loop inductance may for example be 0.3 nH, though other values are possible. In step 232, the tool 110 receives from the PCB designer the layout of the PCB, including all semiconductor dies 154, decoupling capacitors, the all vias, ground and power planes defining the inductance loops for each decoupling capacitor and its associated semiconductor die. Examples of such layouts are shown in FIGS. 5-7.

In step 234, the tool determines the lengths of all current loops 160, including for example current loops 160 shown in FIGS. 6 and 7. In step 236, the tool 110 calculates inductance for each current loop 160, using the determined current loop lengths and the formula 7 above for determining loop inductance.

In step 238, the tool 110 determines whether the loop inductance for a given current loop 160 exceeds the predetermined maximum. If it is determined in step 238 that the loop inductance for an individual current loop exceeds the predetermined maximum, then the PCB designer is informed of this in step 240, and is invited to redesign the current loop(s) in a way that will reduce the current loop length and, consequently, the loop inductance. In embodiments, the loop inductance tool 110 may make recommendations on how to reduce loop inductance in the one or more current loops that exceed the predetermined maximum, for example by analyzing the proposed current loops and recognizing a loop having a shorter overall distance through the one or more vias 130 and/or the one or more ground/power planes 134, 136. The flow then returns to step 232 where the PCB designer can make changes to one or more of the current loops 160. On the other hand, if it is determined in step 238 that the loop inductance for the individual current loops 160 are within the predetermined maximum, then the flow continues to step 242 as explained below.

It is possible that any redesign of the PCB 122 will result in a change in the direct current (DC) voltage drop across the circuits of PCB 122. DC voltage drop refers to the decrease in voltage experienced across a circuit or interconnect path when DC flows through it. In PCB 122, this drop occurs due to the resistance encountered by the current as it travels through the conductive materials, such as the vias 130, ground and power planes 134 and 136, and other interconnects. There needs to be a sufficient number of vias and traces in the ground and power planes, of sufficient cross-sectional, to prevent voltage drop above a predefined minimum. This predefined minimum may be provided by specification and known to the PCB designer.

In step 242, the loop inductance tool 110 measures the voltage drop resulting from any redesign necessitated by steps 234-240 (or by the circuit without redesign in steps 234-240). In step 244, the tool 110 determines whether the voltage drop exceeds the predetermined maximum. If it is determined in step 244 that the voltage drop through the PCB exceeds the predetermined maximum, then the PCB designer is informed of this in step 246, and is invited to redesign the circuits of PCB 122 in a way that will reduce the current drop. The flow then returns to step 232 where the PCB designer can make changes to the circuit.

Any redesign of the circuit in response to step 244 should still take into account loop inductance. Thus, upon making changes to the circuit in step 232, the loop inductance tool 110 again performs steps 234-240 as described above to ensure that the loop inductance of current loops 160 remains below the predetermined maximum. The steps 234-246 are performed (possibly multiple times), allowing the PCB designer to make changes until both the loop inductance of current loops 160 are below the predetermined maximum, and the voltage drop is above the predetermined maximum. Upon reaching this goal, the loop inductance engine moves to step 248 for decoupling capacitor and PDN (power distribution network) optimization, as explained in the following paragraph.

In step 248, after the capacitor loop inductance and DC analysis, capacitor and PDN optimization are performed using the capacitor loop inductance data. This data was calculated in steps 234-236. In step 248, the loop inductance tool 110 optimizes the number and type of decoupling capacitors used, as well as PDN impedance. At a high level, this is done by performing an alternating current (AC) frequency domain simulation to ensure that AC ripple is within the limits set by an AC specification. This AC analysis ensures the required PDN impedance to reduce/contain the voltage ripple caused by different frequencies of the current. This can be expressed as an equation:

$$V ( f ) = {I}_{A C} ( f ) * Z ( f ) , \qquad ( 8 )$$

where I_{AC}(f) is the alternating current at a given frequency; Z=impedance of the PDN at a given frequency; and V(f) is the voltage ripple. All parameters are a function of frequency.

In order to reduce/contain voltage ripple (V(f)), the PCB designer may remove or change the positions of decoupling capacitors, to optimize both decoupling capacitor usage and PDN impedance. One process for performing optimization of decoupling capacitors and PDN impedance uses the following steps. First, the loop inductance data for all decoupling capacitors are arranged in descending order. Again, this data was gathered in steps 234-236. Next, the PCB designer may remove one or more of the highest loop inductance decoupling capacitors and run the AC frequency domain simulation given by equation (8) for the circuit before and after removal of the one or more highest loop inductance capacitors.

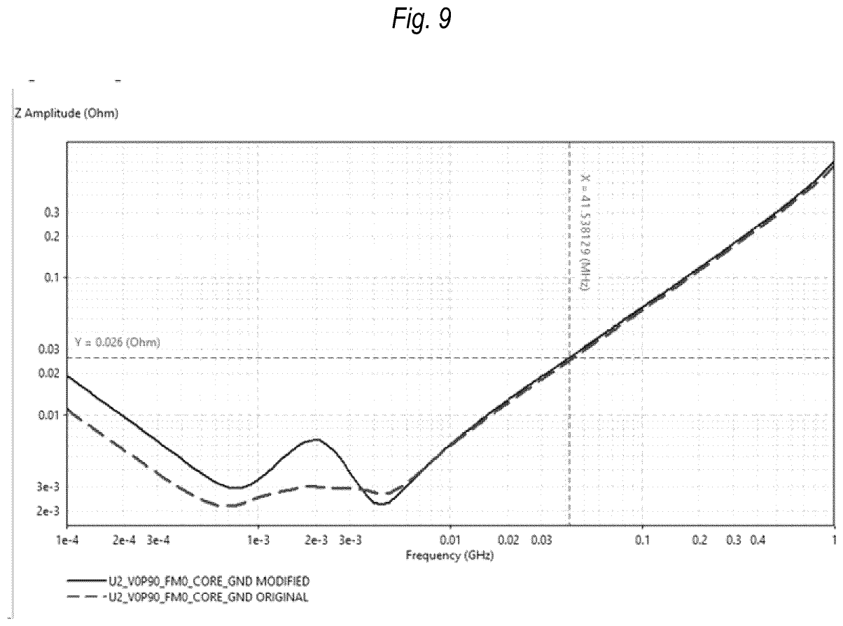

If the overlapped original and modified frequency domain curve looks similar at the high-frequency region as shown in FIG. 9 and PDN impedance (Zpdn) is less than or equal to a predefined target impedance (Ztarget), the PCB designer can remove the first group of one or more highest loop inductance capacitors. The example of FIG. 9 shows the original frequency domain curve (solid line) and the modified frequency domain curve (dashed lines) with the first group of decoupling capacitors removed. As seen, in the high-frequency region (>0.01 GHz), the original and modified frequency domain curves look the same. This is an indication that the first group of one or more high loop inductance capacitors can be removed. The PCB designer can then perform the above steps for the next lower loop inductance decoupling capacitors successively until all decoupling capacitors have been analyzed and, if allowed per the above steps, removed.

In the above comparison of PDN impedance (Zpdn) and target impedance (Ztarget), the target impedance may be given by a specification. Alternatively, target impedance can be calculated using the below formula:

$${Z}_{TARGET} = \frac{Voltage Rail \times \% Ripple}{0.5 \times IMax} . \qquad ( 9 )$$

Using the above steps, high impedance loop inductance capacitors may be removed from a PCB design. Alternatively, instead of removing a given decoupling capacitor, it may be replaced with a small value decoupling capacitor, for example changing a capacitor from 0.1 uF to 1 uF. Other substitutions of decoupling capacitor values are possible.

FIG. 10 illustrates an exemplary computing system 300 that may be computing device 100 or other device used to implement embodiments of the present technology. The computing system 300 of FIG. 10 includes one or more processors 310 and main memory 320. Main memory 320 stores, in part, instructions and data for execution by processor unit 310. Main memory 320 can store the executable code when the computing system 300 is in operation. The computing system 300 of FIG. 10 may further include a mass storage device 330, portable storage medium drive(s) 340, output devices 350, user input devices 360, a display system 370, and other peripheral devices 380.

The components shown in FIG. 10 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 can store the system software for implementing embodiments of the present invention for purposes of loading that software into main memory 320.

Portable storage medium drive(s) 340 operate in conjunction with a portable non-volatile storage medium, such as a floppy disk, compact disk or Digital video disc, to input and output data and code to and from the computing system 300 of FIG. 10. The system software for implementing embodiments of the present invention may be stored on such a portable medium and input to the computing system 300 via the portable storage medium drive(s) 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 10 includes output devices 350. Suitable output devices include speakers, printers, network interfaces, and monitors. Where computing system 300 is part of a mechanical client device, the output device 350 may further include servo controls for motors within the mechanical device.

Display system 370 may include a liquid crystal display (LCD) or other suitable display device. Display system 370 receives textual and graphical information, and processes the information for output to the display device.

Peripheral device(s) 380 may include any type of computer support device to add additional functionality to the computing system. Peripheral device(s) 380 may include a modem or a router.

The components contained in the computing system 300 of FIG. 10 are those typically found in computing systems that may be suitable for use with embodiments of the present invention and are intended to represent a broad category of such computer components that are well known in the art. Thus, the computing system 300 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, an example of the present technology relates to a system for the design of a printed circuit board (PCB), comprising: one or more processors; a memory storing: an insertion loss tool which, when executed by the one or more processors, measures insertion losses along one or more signal paths in a layout of the PCB; and an inductive loop tool which, when executed by the one or more processors, measures inductive losses along a current loop connecting a proposed positions of a semiconductor die in the layout of the PCB and a decoupling capacitor associated with the semiconductor die in the layout of the PCB.

In another example, the present technology relates to a method of designing a PCB having insertion losses within predefined limits, comprising the steps of: storing trace and via parameters for traces and vias used in the design of the PCB; storing a maximum allowable insertion loss for signal paths having a starting point at one of the first and second surfaces of the PCB and an end point at one of the first and second surfaces of the PCB; receiving a proposed layout of the PCB including a layout of vias and traces; analyzing the proposed layout to determine insertion losses along one or more signal paths; and generating a message that one or more of the signal paths require redesign where one or more of the signal paths have insertion losses above the predefined maximum.

In a further example, the present technology relates to a method of designing a PCB having loop inductances along current paths within predefined limits, comprising the steps of: storing a maximum allowable loop inductance for current loops electrically coupling proposed semiconductor dies to proposed decoupling capacitors; receiving a proposed layout of the PCB including a layout of vias ground planes, signal planes, the proposed semiconductor dies and the proposed decoupling capacitors; analyzing the proposed layout to determine loop inductance along the one or more current loops; and generating a message that one or more of the current loops require redesign where one or more of the current loops have a loop inductance above the predefined maximum.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

I claim:

1. A system for the design of a printed circuit board (PCB), comprising:
one or more processors;
a memory storing:
an insertion loss tool which, when executed by the one or more processors, measures insertion losses along one or more signal paths in a layout of the PCB; and
an inductive loop tool which, when executed by the one or more processors, measures inductive losses along a current loop connecting a proposed positions of a semiconductor die in the layout of the PCB and a decoupling capacitor associated with the semiconductor die in the layout of the PCB.

2. The system of claim 1, wherein the insertion loss tool receives a proposed layout of the PCB including vias and traces and determines insertion losses along a signal path including a subset of vias and traces.

3. The system of claim 2, wherein the insertion loss tool measures and sums lengths of vias and traces in the signal path and determines insertion losses along the signal path based in part of the summed lengths of the vias and traces.

4. The system of claim 1, wherein the insertion loss tool recommends that a redesign of the proposed layout of the PCB be performed where the insertion losses along the signal path exceed a predefined maximum.

5. The system of claim 4, wherein the insertion loss tool makes a recommendation of how to redesign the proposed layout of the PCB to reduce insertion losses along the signal path.

6. The system of claim 5, wherein the recommendation made by the insertion loss tool is based on analysis of the current proposed layout of the PCB and finding a shorter signal path comprised of one or more of a shorter path through traces on the PCB and a shorter path through vias on the PCB.

7. The system of claim 1, wherein the loop inductance tool receives a proposed layout of the PCB including a semiconductor die, a decoupling capacitor, vias, power planes and ground planes and determines loop inductance along a current path comprising a subset of vias, a power plane and a ground plane between the semiconductor die and the decoupling capacitor.

8. The system of claim 7, wherein the loop inductance is based in part on a distance current travels along the current path.

9. The system of claim 1, wherein the loop inductance tool recommends that a redesign of the proposed layout of the PCB be performed where the loop inductance along the current loop exceeds a predefined maximum.

10. The system of claim 9, wherein the loop inductance tool makes a recommendation of how to redesign the proposed layout of the PCB to reduce loop inductance along the current loop.

11. The system of claim 10, wherein the recommendation made by the loop inductance tool is based on analysis of the current proposed layout of the PCB and finding a shorter current loop comprised of one or more of a shorter path through a ground plane on the PCB, a shorter path through a power plane on the PCB and a shorter path through vias on the PCB.

12. A method of designing a PCB having insertion losses within predefined limits, comprising the steps of:
(a) storing trace and via parameters for traces and vias used in the design of the PCB;
(b) storing a maximum allowable insertion loss for signal paths having a starting point at one of the first and second surfaces of the PCB and an end point at one of the first and second surfaces of the PCB;
(c) receiving a proposed layout of the PCB including a layout of vias and traces;
(d) analyzing the proposed layout to determine insertion losses along one or more signal paths; and
(e) generating a message that one or more of the signal paths require redesign where one or more of the signal paths have insertion losses above the predefined maximum.

13. The method of claim 12, further comprising the step of storing a Nyquist frequency for the signal paths in the proposed layout of the PCB.

14. The method of claim 12, further comprising the step of redesigning the one or more signal paths indicated to have insertion losses above the predefined maximum by shortening a length of one or more of the vias and traces in the one or more signal paths indicated to have insertion losses above the predefined maximum.

15. A method of designing a PCB having loop inductances along current paths within predefined limits, comprising the steps of:
(a) storing a maximum allowable loop inductance for current loops electrically coupling proposed semiconductor dies to proposed decoupling capacitors;
(b) receiving a proposed layout of the PCB including a layout of vias ground planes, signal planes, the proposed semiconductor dies and the proposed decoupling capacitors;
(c) analyzing the proposed layout to determine loop inductance along the one or more current loops; and
(d) generating a message that one or more of the current loops require redesign where one or more of the current loops have a loop inductance above the predefined maximum.

16. The method of claim 15, further comprising the step of redesigning one or more current loops indicated to have loop inductances above the predefined maximum.

17. The method of claim 16, wherein said step of redesigning the one or more current loops comprises the step of shortening a length of the one or more current loops one or more of the vias and traces in the one or more signal paths indicated to have insertion losses above the predefined maximum.

18. The method of claim 16, wherein said step of redesigning the one or more current loops comprises the step of removing or changing a value of a decoupling capacitor.

19. The method of claim 15, further comprising the step of measuring a direct current (DC) voltage drop across proposed circuit on the layout of the PCB and redesigning the proposed circuit if the DC voltage drop is above a predefined maximum.

20. The method of claim 15, further comprising the step of optimizing the number and type of proposed decoupling capacitors and an overall power distribution network (PDN) impedance by performing an alternating current (AC) frequency domain simulation to ensure that AC ripple is within limits set by a predefined AC specification.
